(19) United States
(12) Patent Application Publication
(10) Pub. No.: US 2012/0262342 A1
(43) Pub. Date: Oct. 18, 2012

(54) MULTIBAND ANTENNA

(75) Inventor: YI-CHIEH LEE, Tu-Cheng (TW)

(73) Assignee: CHI MEI COMMUNICATION SYSTEMS, INC., Tu-Cheng (TW)

(21) Appl. No.: 13/181,653

(22) Filed: Jul. 13, 2011

(30) Foreign Application Priority Data
Apr. 18, 2011 (TW) 100113418

(51) Int. Cl. H01Q 5/01

(52) U.S. Cl. 343/700 MS

(57) ABSTRACT

A multiband antenna includes a feed unit, a ground unit, a first radiator unit, a second radiator unit, a first resonance unit, and a second resonance unit. When feed signals are input to the feed unit, the feed signals are transmitted to the first radiator unit and the second radiator to form current paths of different lengths, and the first resonance unit and the second resonance unit are driven to resonate and respectively generate additional current paths of different lengths. In this way, the first radiator unit, the second radiator unit, the first resonance unit, and the second resonance unit are enabled to receive and send wireless signals of different frequencies.

### BACKGROUND

1. Technical Field

The present disclosure relates to antennas, and particularly to a multiband antenna.

2. Description of Related Art

Many portable electronic devices, such as mobile phones, personal digital assistants, and laptop computers often use multiband antennas to receive/send wireless signals of different frequencies.

However, multiband antennas tend to be large with a complicated structure, compromising efforts toward the miniaturization of portable electronic devices. Even where installation of miniaturized multiband antennas within such portable electronic devices is possible, communication capabilities of miniaturized multiband antennas may be adversely affected due to their limited size. For example, many multiband antennas used in portable electronic devices are unable to receive/send wireless signals in more than two frequency bands.

Therefore, there is room for improvement within the art.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment.

FIG. 1 is a schematic view of a multiband antenna, according to an exemplary embodiment.

FIG. 2 is similar to FIG. 1, but viewed from another angle.

FIG. 3 is a diagram showing a return loss measurement of the multiband antenna shown in FIG. 1.

### DETAILED DESCRIPTION

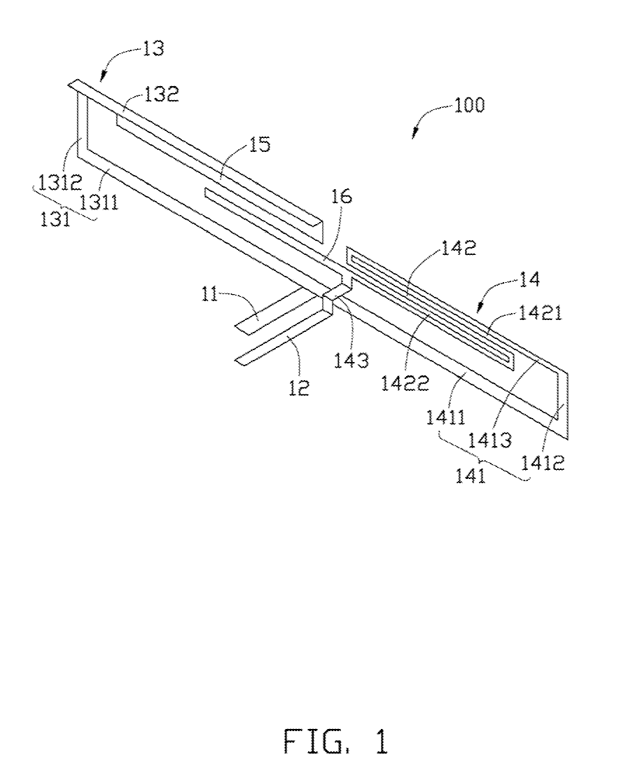

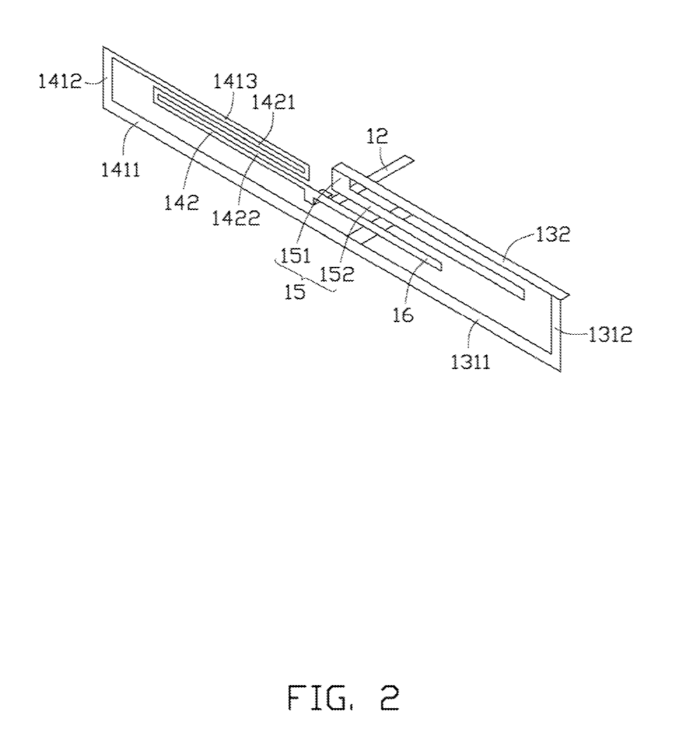

FIG. 1 and FIG. 2 show a multiband antenna 100, according to an exemplary embodiment. The multiband antenna 100 consists of conductive sheets, with size and profile thereof minimized, for suitable use in a portable electronic device such as a mobile phone, a personal digital assistant, or a laptop computer. The conductive sheets can be metal sheets, flexible printed circuits, or other materials.

The multiband antenna 100 includes a feed unit 11, a ground unit 12, a first radiator unit 13, a second radiator unit 14, a first resonance unit 15, and a second resonance unit 16.

The feed unit 11 and the ground unit 12 are positioned adjacent to but separated from each other, which are both longitudinal planar sheets.

The first radiator unit 13 includes a first radiator portion 131, and a second radiator portion 132. The first radiator portion 131 is positioned in a plane that is perpendicular to the plane in which the feed unit 11 and the ground unit 12 are positioned. The second radiator portion 132 is in a plane that is perpendicular to the plane in which the first radiator portion 131 is positioned. The first radiator portion 131 includes a first radiator section 1311, and a second radiator section 1312, which are both longitudinal planar sheets. One end of the first radiator section 1311 is connected to a distal end of the feed unit 11. The other end of the first radiator section 1311 is perpendicularly connected to one side of an end of the second radiator section 1312. The second radiator portion 132 is a longitudinal planar sheet. The second radiator portion 132 and the first radiator section 1311 are positioned at a same side of the second radiator section 1312. The second radiator portion 132 is perpendicularly connected to an end of the second radiator section 1312 away from the first radiator section 1311.

The second radiator unit 14 is coplanar with the first radiator portion 131. The second radiator unit 14 includes a third radiator portion 141, a fourth radiator portion 142, and a fifth radiator portion 143. The third radiator portion 141 is a U-shaped planar sheet. The third radiator portion 141 includes a third radiator portion 1411, a fourth radiator portion 1412, and a fifth radiator section 1413. The third radiator portion 1411 is connected to the feed unit 11 and the first radiator section 1311, and positioned to be collinear with the first radiator section 1311 and extends away from the first radiator section 1311. The fourth radiator section 1412 is perpendicularly connected to the third radiator section 1411 and the fifth radiator section 1413.

The fourth radiator portion 142 is a rectangular planar sheet. The fourth radiator portion 142 and the fourth radiator section 1412 are set at a same side of the fifth radiator section 1413, and the fourth radiator portion 142 is perpendicularly connected to a side of an end of the fifth radiator section 1413. The fourth radiator portion 142 defines a first slot 1421 and a second slot 1422 thereon. The first slot 1421 and the second slot 1422 are respectively set at two opposite sides of the fourth radiator portion 142. Accordingly, the fourth radiator portion 142 forms a square wave period structure.

The fifth radiator portion 143 is a step-shaped planar sheet. The fifth radiator portion 143 is perpendicularly connected to the fourth radiator portion 142 and the ground unit 12. Therefore, the feed unit 12, the second radiator unit 14, and the ground unit 12 are connected in that order and form a current loop.

The first resonance unit 15 is coplanar with the first radiator portion 131. The first resonance unit 15 includes a first resonance section 151 and a second resonance section 152, which are both longitudinal planar sheets. The first resonance section 151 and the second radiator section 1312 are set at a same side of the second radiator portion 132. Particularly, the first resonance section 151 is perpendicularly connected to a side of an end of the second radiator portion 132, and parallel to the second radiator section 1312. The second radiator section 1312 is longer than the first resonance section 151. The second resonance section 152 is perpendicularly connected to an end of the first resonance section 151, and extends towards the second radiator section 1312.

The second resonance unit 16 is coplanar with the first radiator portion 131 and the first resonance unit 15. The second resonance unit 16 is a longitudinal planar sheet. The second resonance unit 16 is connected to the fourth radiator portion 142 and the fifth radiator portion 143, and extends towards the second radiator section 1312 and is parallel to the second resonance section 152.

When the multiband antenna 100 is used, the ground unit 12 can be attached to a circuit board (not shown) of the portable electronic device to be grounded, and the feed unit 11 is connected to the circuit board to receive feed signals. Feed signals input from the feed unit 11 can be transmitted to the first radiator unit 13 and the second radiator unit 14 to form two current paths of different lengths. Thus, the first radiator unit 13 and the second radiator unit 14 respectively generate a low frequency mode and a high frequency mode, and enabled to serve as antenna members for receiving and sending wireless signals at different frequencies. Simultaneously, the first resonance unit 15 and the second resonance unit 16 are driven to resonate due to current through the first radiator unit 13 and the second radiator unit 14, and generate a first resonance mode and a second resonance mode. Thus, the first resonance unit 15 and the second resonance unit 16 are also enabled to serve as antenna members for receiving and sending wireless signals of predetermined frequencies. Accordingly, the multiband antenna 100 can be used to receive and send wireless signals in a plurality of different frequency bands.

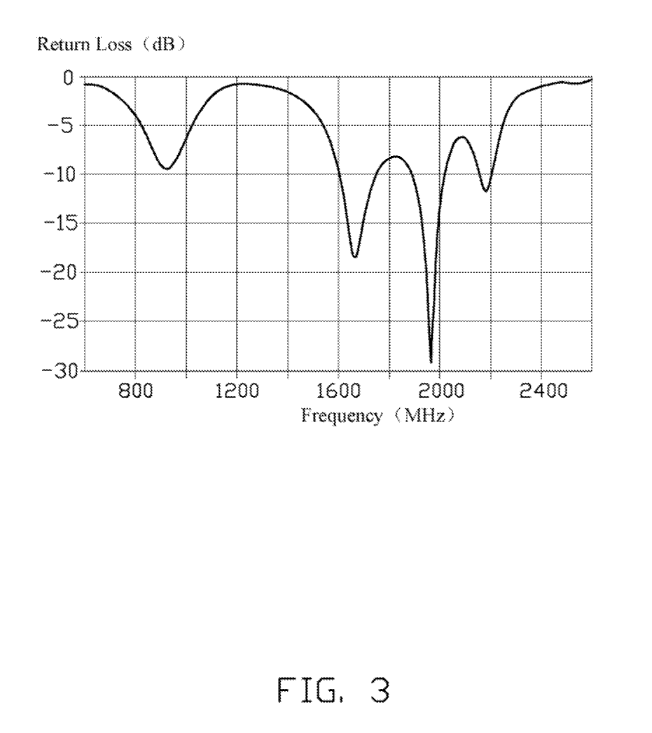

Referring to FIG. 3, as shown in experiments, the return loss (RL) of the multiband antenna 100 is acceptable when the multiband antenna 100 receives/sends wireless signals in multiple frequency bands. Particularly, the RL of the multiband antenna 100 is less than −5 dB when the multiband antenna 100 receive/send wireless signals at frequencies of about 900 MHz, 1650 MHz, 1950 MHz, and 2170 MHz. Accordingly, the electronic device employing the multiband antenna 100 can be used in a plurality of (more than two) common wireless communication systems, such as GSM850, EGSM900, DCS1650, PCS1900, or WCDMA2170, with acceptable communication quality.

Due to the composition disclosed, in assembly, the multiband antenna 100 can be supported and be protected on a cubic substrate (not shown). The feed unit 11 and the ground unit 12 can be attached on a basic surface of the substrate. The second radiator portion 132 can be attached on a top surface of the substrate that is opposite to the basic surface for mounting the feed unit 11 and the ground unit 12. The first radiator portion 131, the second radiator unit 14, the first resonance unit 15, and the second resonance unit 16 can be attached on a side surface of the substrate. Therefore, most parts of the multiband antenna 100 can be flatly attached on the substrate, with an assembly including the substrate and the multiband antenna 100 mounted thereon also defining a substantially cubic outer shape. Accordingly, the multiband antenna 100 is protected from damage, and assembly, installation, and transportation of the multiband antenna 100 are simplified.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A multiband antenna, comprising:
a feed unit;
a ground unit;
a first radiator unit connected to the feed unit;
a second radiator unit connected to the feed unit and the ground unit;
a first resonance unit connected to the first radiator unit; and
a second resonance unit connected to the second radiator unit; wherein when feed signals are input to the feed unit, the feed signals are transmitted to the first radiator unit and the second radiator to form current paths of different lengths; the first resonance unit and the second resonance unit are driven to resonate and respectively generate additional current paths of different lengths; such that the first radiator unit, the second radiator unit, the first resonance unit, and the second resonance unit are enabled to respectively receive and send wireless signals of different frequencies.

2. The multiband antenna as claimed in claim 1, wherein the feed unit and the ground unit are positioned adjacent to but separated from each other, which are both longitudinal planar sheets.

3. The multiband antenna as claimed in claim 1, wherein the first radiator unit includes a first radiator portion, and a second radiator portion; the first radiator portion is connected to the feed unit, the second radiator portion is connected to the first radiator portion and the first resonance unit.

4. The multiband antenna as claimed in claim 3, wherein the first radiator portion is positioned in a plane that is perpendicular to the plane in which the feed unit and the ground unit are positioned, the second radiator portion is positioned in a plane that is perpendicular to the plane in which the first radiator portion is positioned.

5. The multiband antenna as claimed in claim 3, wherein the first radiator portion includes a first radiator section, and a second radiator section, one end of the first radiator section is connected to a distal end of the feed unit, the other end of the first radiator section is perpendicularly connected to one side of an end of the second radiator section.

6. The multiband antenna as claimed in claim 5, wherein the second radiator portion and the first radiator section are positioned at a same side of the second radiator section, the second radiator portion is perpendicularly connected to an end of the second radiator section away from the first radiator section.

7. The multiband antenna as claimed in claim 5, wherein the second radiator unit includes a third radiator portion, a fourth radiator portion, and a fifth radiator portion, the third radiator portion is a U-shaped planar sheet and connected to the feed unit, the fourth radiator portion is connected to the third radiator portion and the fifth radiator portion; the fifth radiator portion is connected to the ground unit.

8. The multiband antenna as claimed in claim 7, wherein the third radiator portion includes a third radiator section, a fourth radiator section, and a fifth radiator section, the third radiator section is connected to the feed unit and the first radiator section, and positioned to be collinear with the first radiator section and extends away from the first radiator section, the fourth radiator section is perpendicularly connected to the third radiator section and the fifth radiator section.

9. The multiband antenna as claimed in claim 8, wherein the fourth radiator portion and the fourth radiator section are set at a same side of the fifth radiator section, and the fourth radiator portion is perpendicularly connected to a side of an end of the fifth radiator section.

10. The multiband antenna as claimed in claim 7, wherein the fourth radiator portion defines a first slot and a second slot thereon, the first slot and the second slot are respectively set at two opposite sides of the fourth radiator portion, accordingly, the fourth radiator portion forms a square wave period structure.

11. The multiband antenna as claimed in claim 7, wherein the fifth radiator portion is a step-shaped planar sheet, the fifth radiator portion is perpendicularly connected to the fourth radiator portion and the ground unit, therefore, the feed unit, the second radiator unit, and the ground unit are connected in that order and form a current loop.

12. The multiband antenna as claimed in claim 5, wherein the first resonance unit is coplanar with the first radiator portion, the first resonance unit includes a first resonance section and a second resonance section, the first resonance section and the second radiator section are set in a same side of the second radiator portion, the first resonance section is perpendicularly connected to a side of an end of the second radiator portion, and parallel to the second radiator section, the second resonance section is perpendicularly connected to an end of the first resonance section, and extends towards the second radiator section.

13. The multiband antenna as claimed in claim 5, wherein the second resonance unit is coplanar with the first radiator portion and the first resonance unit, the second resonance unit is connected to the fourth radiator portion and the fifth radiator portion, and extends towards the second radiator section and is parallel to the second resonance section.

14. A multiband antenna, comprising:
a feed unit;
a ground unit;
a first radiator unit connected to the feed unit;
a second radiator unit connected to the feed unit and the ground unit;
a first resonance unit connected to the first radiator unit; and
a second resonance unit connected to the second radiator unit; wherein when feed signals are input to the feed unit, the feed signals are transmitted to the first radiator unit and the second radiator, and generate a low frequency mode and a high frequency mode; the first resonance unit and the second resonance unit are driven to resonate and respectively generate a first resonance mode and a second resonance mode.
